(19) United States
(12) Patent Application Publication
(10) Pub. No.: US 2011/0137670 A1
(43) Pub. Date: Jun. 9, 2011

(54) METHODS, APPARATUSES, AND COMPUTER PROGRAM PRODUCTS FOR FACILITATING DEVELOPMENT AND EXECUTION OF A CLINICAL CARE PLAN

(75) Inventor: Karen Utterback, Hattiesburg, MS (US)

(73) Assignee: McKesson Financial Holdings Limited

(21) Appl. No.: 12/631,356

(22) Filed: Dec. 4, 2009

(51) Int. Cl. G06Q 50/00

(52) U.S. Cl. 705/2

(57) ABSTRACT

Methods, apparatuses, and computer program products are provided for facilitating development and execution of a clinical care plan. A method may include determining patient assessment data for a patient. The method may further include processing the patient assessment data to determine based at least in part upon a system for clinical practice and documentation a problem faced by the patient. The method may additionally include generating a care plan for the patient to address the determined problem. Generating the care plan may include determining based at least in part upon the determined problem and the system for clinical practice and documentation at least one intervention to treat the problem. Generating the care plan may further include determining based at least in part upon the determined problem a goal of clinical care. Corresponding apparatuses and computer program products are also provided.

### TECHNOLOGICAL FIELD

Embodiments of the present invention relate generally to clinical care of a patient and, more particularly, relate to methods, apparatuses, and computer program products for facilitating development and execution of a clinical care plan.

### BACKGROUND

Clinicians caring for patients are often faced with the task of documenting large amounts of data. In this regard, clinicians may have to document an initial comprehensive assessment of a patient's condition as well as follow-up assessments. Clinicians may further have to develop and document a care plan based on the assessments as well as document progress towards goals of the care plan over time. It may be difficult for clinicians to develop a care plan that is designed to address assessment findings in a way that is based on best and evidenced based practice. Further, agencies and other healthcare settings employing or otherwise responsible for clinicians may need to ensure that care provided by their staff clinicians is delivered in a manner that meets best and evidence based practice guidelines. Agencies and other healthcare settings may further need to document clinician efforts to facilitate consistency in care across an agency and/or consistency in care for a single patient when there is a change in a staff clinician assigned to the patient.

In addition to the development and documentation of a care plan, clinicians and/or supporting agencies may further have to document assessed problems and administered treatments in accordance with various standardized terminology sets that may, for example, be provided to insurers and/or added to an electronic health record for a patient. These documentation requirements may be tedious and may detract from time available for a clinician to care for a patient. Moreover, factors such as an aging population are resulting in an increasing number of patients that are receiving clinical care, such as, for example, home care. Accordingly, documentation requirements imposed on clinicians and agencies are magnified due to the greater number of patients for which documentation is needed.

### BRIEF SUMMARY OF SOME EXAMPLES OF THE INVENTION

Methods, apparatuses, and computer program products are therefore provided for facilitating development and execution of a clinical care plan. In this regard, methods, apparatuses, and computer program products are provided that may provide several advantages to clinicians, healthcare settings, payers (e.g. government and private insurers), and patients. Embodiments of the invention provide for automatic determination of one or more problems facing a patient and generation of a care plan to address the determined care problems based on patient assessment data. The problems may be determined and the care plan may be generated by embodiments of the invention in accordance with best and evidence based practice. In this regard, embodiments of the invention may reduce the burden imposed on clinicians to develop a care plan while also ensuring consistency with best and evidence based practice, thus reducing clinician burden and improving the consistency in the care provided. Some embodiments of the invention further facilitate generation of documentation in accordance with various standardized terminology sets to simplify the provision of documentation to insurers, electronic health records, and/or the like. Accordingly, embodiments of the invention provide for a standardized approach to assessing the patient that is used to generate assessment data used for a wide range of clinical documentation.

In a first example embodiment, a method for facilitating development and execution of a clinical care plan is provided. The method of this embodiment comprises determining patient assessment data for a patient. The method of this embodiment further comprises processing the patient assessment data to determine, based at least in part upon a system for clinical practice and documentation, a problem faced by the patient. The method of this embodiment additionally comprises generating a care plan for the patient to address the determined problem. Generating the care plan according to this embodiment comprises determining based at least in part upon the determined problem and the system for clinical practice and documentation at least one intervention to treat the problem. Generating the care plan according to this embodiment further comprises determining based at least in part upon the determined problem a goal of clinical care.

In another example embodiment, an apparatus for facilitating development and execution of a clinical care plan is provided. The apparatus of this embodiment comprises a processor configured to cause the apparatus to determine patient assessment data for a patient. The processor of this embodiment is further configured to cause the apparatus to process the patient assessment data to determine, based at least in part upon a system for clinical practice and documentation, a problem faced by the patient. The processor of this embodiment is additionally configured to cause the apparatus to generate a care plan for the patient to address the determined problem. The processor of this embodiment is configured to cause the apparatus to generate the care plan by determining, based at least in part upon the determined problem and the system for clinical practice and documentation, at least one intervention to treat the problem. The processor of this embodiment is further configured to cause the apparatus to generate the care plan by determining, based at least in part upon the determined problem, a goal of clinical care.

In another example embodiment, a computer program product for facilitating development and execution of a clinical care plan is provided. The computer program product of this embodiment includes at least one computer-readable storage medium having computer-readable program instructions stored therein. The computer program product of this embodiment comprises program instructions configured for determining patient assessment data for a patient. The computer program product of this embodiment further comprises program instructions configured for processing the patient assessment data to determine, based at least in part upon a system for clinical practice and documentation, a problem faced by the patient. The computer program product of this embodiment additionally comprises program instructions configured for generating a care plan for the patient to address the determined problem. The program instructions of this embodiment configured for generating a care plan comprise program instructions configured for determining, based at least in part upon the determined problem and the system for clinical practice and documentation, at least one intervention to treat the problem. The program instructions of this embodiment configured for generating a care plan further comprise program instructions configured for determining, based at least in part upon the determined problem, a goal of clinical care.

In another example embodiment, an apparatus for facilitating development and execution of a clinical care plan is provided. The apparatus of this embodiment comprises means for determining patient assessment data for a patient. The apparatus of this embodiment further comprises means for processing the patient assessment data to determine, based at least in part upon a system for clinical practice and documentation, a problem faced by the patient. The apparatus of this embodiment additionally comprises means for generating a care plan for the patient to address the determined problem. The means for generating the care plan of this embodiment comprise means for determining, based at least in part upon the determined problem and the system for clinical practice and documentation, at least one intervention to treat the problem. The means for generating the care plan of this embodiment further comprise means for determining, based at least in part upon the determined problem, a goal of clinical care.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates an apparatus for facilitating development and execution of a clinical care plan according to an exemplary embodiment of the present invention;

FIG. 2 illustrates a system for facilitating development and execution of a clinical care plan according to an exemplary embodiment of the present invention;

FIG. 3 illustrates a model of associations between clinical data content according to an exemplary embodiment of the present invention;

FIGS. 4-9 illustrate a series of screen captures of an example user interface for defining associations between clinical data content and assessment question response options according to an example embodiment of the invention;

FIGS. 10-20 illustrate an interface and method for assessing a patient, generating a care plan, and documenting progress on the care plan according to an example embodiment of the invention;

FIG. 21 illustrates a flowchart according to an exemplary method for facilitating development and execution of a clinical care plan according to an exemplary embodiment of the invention; and

FIG. 22 illustrates a flowchart according to an exemplary method for updating a clinical care plan based on a follow-up assessment according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

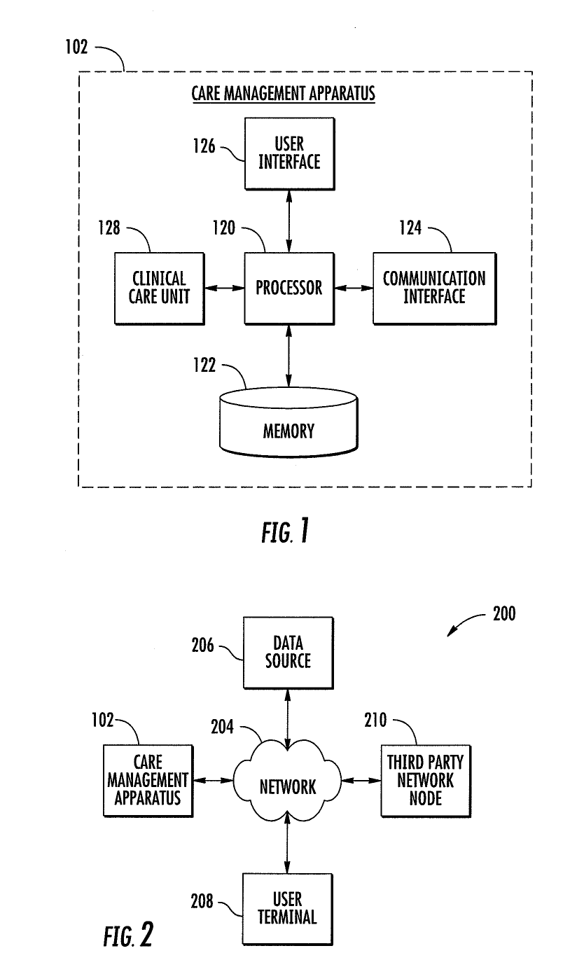

FIG. 1 illustrates a care management apparatus 102 for facilitating development and execution of clinical care plan, such as, for example, a home care clinical care plan, according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a care management apparatus for facilitating development and execution of a clinical care plan, numerous other configurations may also be used to implement embodiments of the present invention.

The care management apparatus 102 may be embodied as a server, desktop computer, laptop computer, mobile terminal, mobile computer, mobile phone, mobile communication device, audio/video player, television device, network node, multiple computing devices in communication with each other, any combination thereof, and/or the like. In an exemplary embodiment, the care management apparatus 102 includes various means, such as a processor 120, memory 122, communication interface 124, user interface 126, and clinical care unit 128 for performing the various functions herein described. These means of the care management apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be embodied on a single computing device or may be distributed across a plurality of computing devices collectively configured to function as the care management apparatus 102. The plurality of processors may be in operative communication with each other and may be collectively configured to perform one or more functionalities of the care management apparatus 102 as described herein. In an exemplary embodiment, the processor 120 is configured to execute instructions stored in the memory 122 or otherwise accessible to the processor 120. These instructions, when executed by the processor 120, may cause the care management apparatus 102 to perform one or more of the functionalities of the care management apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The plurality of memories may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the care management apparatus 102 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the clinical care unit 128 during the course of performing its functionalities.

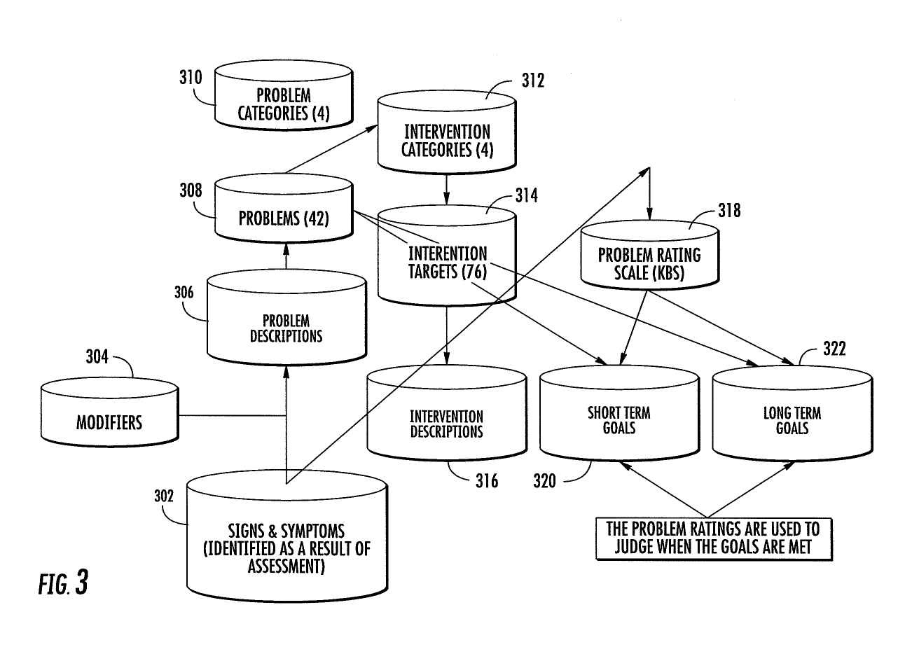

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another device, such as, for example, a server, a user terminal (e.g., the user terminal 208 illustrated in FIG. 2), a data source (e.g., the data source 206 illustrated in FIG. 2), a third party network node (e.g., the third party network node 210 illustrated in FIG. 2), and/or the like. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver, network interface card, and/or supporting hardware or software for enabling communications with another computing device. The communication interface 124 may be configured to receive and/or transmit data using any protocol that may be used for communications between computing devices. The communication interface 124 may additionally be in communication with the memory 122, user interface 126, and/or clinical care unit 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the care management apparatus 102 is embodied as a server, aspects of the user interface 126 may be reduced or the user interface 126 may even be eliminated. Alternatively, such as in embodiments wherein the care management apparatus 102 is embodied as a server, at least some aspects of the user interface 126 may be embodied on an apparatus used by a user that is in communication with the care management apparatus 102, such as for example, the user terminal 208 illustrated in FIG. 2. The user interface 126 may be in communication with the memory 122, communication interface 124, and/or clinical care unit 128, such as via a bus.

The clinical care unit 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the clinical care unit 128 is embodied separately from the processor 120, the clinical care unit 128 may be in communication with the processor 120. The clinical care unit 128 may further be in communication with one or more of the memory 122, communication interface 124, or user interface 126, such as via a bus.

FIG. 2 illustrates a system 200 for facilitating development and execution of a clinical care plan according to an exemplary embodiment of the present invention. In this regard, FIG. 2 illustrates a system wherein the care management apparatus 102 comprises and/or is embodied as a node on a network 204. The network 204 may comprise a wireless network (e.g., a cellular network, wireless local area network, wireless personal area network, wireless metropolitan area network, and/or the like), a wireline network, or some combination thereof, and in some embodiments comprises the internet.

The system 200 may comprise one or more data sources 206 in communication with the care management apparatus 102 to facilitate access by the care management apparatus 102 to remotely stored data. The remotely stored data may comprise, for example, patient medical data, patient electronic health records, patient/member demographic data, clinical support content (e.g., content supporting a system for clinical practice and documentation, International Classification of Diseases codes, standardized clinical terminology identifiers, and/or the like). The data source 206 may comprise, for example, a network attached storage device, a server, a desktop computer, laptop computer, mobile terminal, mobile computer, mobile phone, mobile communication device, audio/video player, any combination thereof, and/or the like. A data source may be maintained by a clinician agency, payer (e.g., insurer), medical services provider, clinic, hospital, doctor's office, other healthcare setting, and/or the like. It will be appreciated that when the clinical care unit 128 is described herein to access data or information from the memory 122, accessing data from the memory 122 is provided merely for purposes of example and the clinical care unit 128 may be configured to access data from the memory 122 and/or from a data source(s) 206 over the network 204.

The system 200 may additionally or alternatively comprise one or more user terminals 208. In this regard, in embodiments wherein the care management apparatus 102 comprises one or more servers, the one or more servers may be in communication with one or more remote user terminals 206 over the network 204 to facilitate a user of a user terminal 208 to remotely access at least some of the functionality provided by the care management apparatus 102 in accordance with embodiments of the invention. Such an arrangement may allow multiple users at multiple user terminals 208 to concurrently access functionality provided by the care management apparatus 102. A user terminal 208 may comprise any device configured for use by a user to access functionality provided by the care management apparatus 102 over the network 204. In this regard, a user terminal 208 may be embodied as a desktop computer, laptop computer, mobile terminal, mobile computer, mobile phone, mobile communication device, audio/video player, television device, any combination thereof, and/or the like.

In embodiments wherein a user terminal 208 is used to access functionality provided by the care management apparatus 102, elements of the care management apparatus 102 that were described with respect to FIG. 1 and functionality attributed thereto may be distributed between the care management apparatus 102 and user terminal 208. For example, the clinical care unit 128 may be distributed between the care management apparatus 102 and user terminal 208, such that functionality attributed to the clinical care unit 128 may be performed by the care management apparatus 102 and/or by the user terminal 208. Additionally or alternatively, where the clinical care unit 128 is said to cause a graphical user interface, data, and/or the like to be displayed, it will be appreciated that the clinical care unit 128 may be configured to cause the graphical user interface, data, and/or the like to be displayed on a display coupled to the care management apparatus 102 and/or may be configured to cause transmission of the data to be displayed via the communication interface 124 to a user terminal 208 such that the graphical user interface, data, and/or the like may be displayed on a display coupled to the user terminal 208. Similarly, where receipt of a selection of a response to an assessment question and/or receipt of other user input is described, it will be appreciated that the user may be providing the selection or input via the user interface 126 and/or may be interacting with a user terminal 208 such that the input and/or selection is transmitted from the user terminal 208 to the care management apparatus 102, where it may be received by the communication interface 124 and/or clinical care unit 128. Further, program instructions, data, and/or the like said to be stored in the memory 122 may be stored at the care management apparatus 102 and/or may be stored on a user terminal 208.

The system 200 may further include one or more third party network nodes 210. A third party network node 210 may comprise any computing device operated and/or managed by a third party that is configured to communicate and exchange data with the care management apparatus 102 over the network 204. A third party network node 210 may, for example, comprise a repository of electronic health records. As described with respect to various embodiments of the invention, the care management apparatus 102 may be configured to provide information for inclusion in an electronic health record to a third party network node 210 and/or may be configured to update an electronic health record stored at a third party network node 210. In another example, a third party network node 210 may be operated by a payer and the care management apparatus 102 may be configured to provide documentation and/or other information to the third party network node 210 for use by the payer.

A set of assessment questions may be stored in the memory 122. These assessment questions may comprise a set of assessment questions configured to allow a clinician to assess a condition of a patient. The clinician may comprise, for example, a caregiver nurse, physical therapist, occupational therapist, health aide, speech therapist, social worker, dietician, respiratory therapist, community worker, and/or the like. In this regard, the set of assessment questions may comprise questions through which problem(s) facing the patient (e.g., an individual problem, problem with respect to the patient's family, problem with respect to the patient's community, health promotion problem, potential medical problem, actual medical problem, problem with respect to the patient's knowledge, problem with respect to the patient's behavior, and/or the like) may be determined based on responses to the questions provided by the patient, clinician, caregiver, and/or other individual. The set of assessment questions may further comprise one or more questions that may facilitate determination of situations that will affect the care provided to the patient by the clinician. For example, if patient is not receptive to teaching, then teaching-based interventions may not provide a viable treatment for a problem facing the patient. The assessment questions may additionally comprise one or more questions used to derive the appropriate responses and subsequent scoring attribute to various risk assessment tools. Such risk assessment tools may include, for example, Braden Scale, Berg, Glasgow, and/or the like.

Respective assessment questions in the assessment question set may have a plurality of predefined response options from which an individual may select to provide an answer to the assessment question. For example, an assessment question requiring a “yes” or “no” response may have two predefined response options—a “yes” response option and a “no” response option. Other assessment questions may have more than two predefined response options. Some assessments question may require an individual to provide a response comprising a relative range or degree. For example, an assessment question may require a response as to how severe a patient's pain is. Such an assessment question may have predefined response options for “no pain,” “minimal pain,” “moderate pain,” “severe pain,” and “extreme pain.” It will be appreciated that the above example assessment question types and response options are provided merely for purposes of example and not by way of limitation. In this regard, embodiments of the invention are not limited to any assessment question context or answer type. An assessment question set in accordance with some embodiments of the invention comprises any one or more assessment questions having predefined response options.

The memory 122 may further store predefined associations between assessment question response options and clinical data content. The clinical care unit 128 may be configured to define and direct storage of the associations, such as in response to user input, as will be subsequently described. The clinical care unit 128 may be further configured to determine problems facing a patient, derive reporting data, and/or the like by processing patient assessment data comprising responses to patient assessment questions. In this regard, the responses may comprise selected assessment question response options for respective assessment questions, which the clinical care unit 128 may be configured to look up in the memory 122 to determine clinical data content associated with the selected assessment question response options. The clinical care unit 128 may then use the determined associated clinical data content to determine problems facing a patient, derive reporting data, and/or the like.

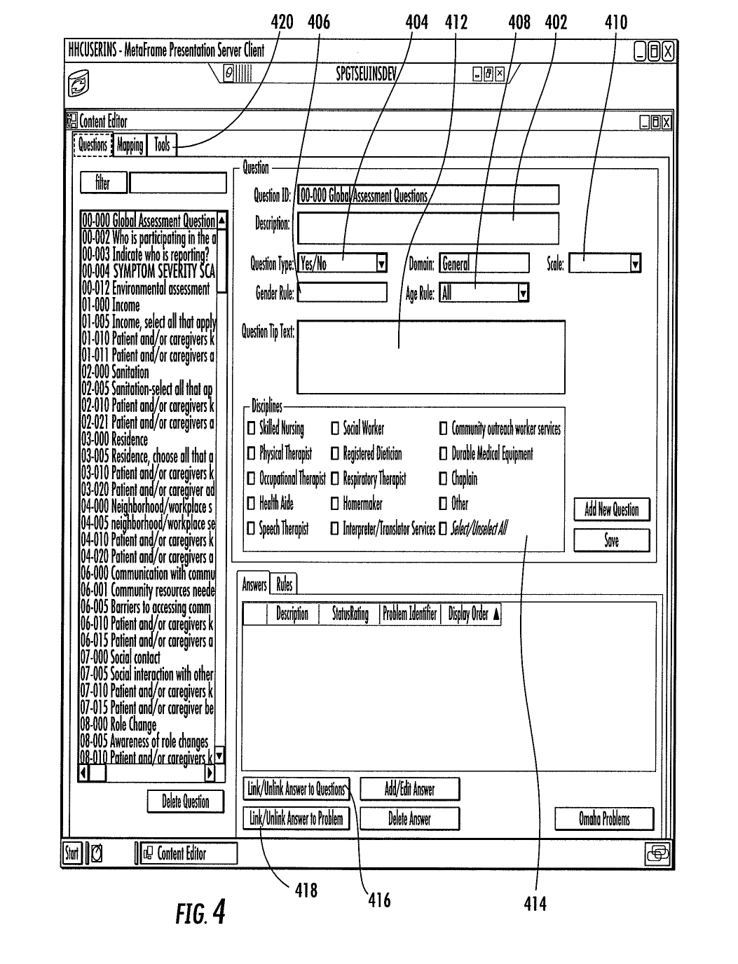

It will be appreciated that the clinical data content may comprise any information that may be mapped to assessment question response options and/or other clinical data content to facilitate determination of problems facing a patient, derive reporting data, and/or the like. In some embodiments, the clinical data content comprises a system for clinical practice and documentation. The system for clinical practice and documentation may comprise any clinical data system comprising clinical data content defining respective problems that may be faced by a patient (e.g., an assessment component) and interventions for those problems (e.g., an intervention component). In an example embodiment, the system for clinical practice and documentation comprises the Omaha System, but is not limited to such and may comprise any appropriate system for clinical practice and documentation that includes at least some of the features discussed above. An example model of such a system for clinical practice and documentation having predefined associations defined in accordance with one example embodiment of the invention is illustrated in FIG. 3. In this regard, FIG. 3 illustrates an example model of associations between clinical data content defined in accordance with one embodiment of the invention in which the Omaha System is used as a basis for a system for clinical practice and documentation.

The system for clinical practice and documentation may define classifications for the problems defined by the assessment component. In this regard, problems (e.g., the problems 308) may have a predefined association with one or more respective classifications (e.g., the problem categories 310). In embodiments wherein the Omaha System is used as a basis for the system for clinical practice and documentation, the problems may include the 42 problems specified by the Omaha System. These classifications, or categories, may include, for example, the four classifications identified by the Omaha System, which classify as a problem as a problem in a psychosocial domain, environmental domain, physiological domain, or health related behaviors domain. The classifications for problems defined by the system for clinical practice and documentation may additionally or alternatively include “modifiers” (e.g., the modifiers 304) that may, for example, classify a respective problem as an individual, family, or community problem. The modifiers 304 may additionally or alternatively classify a respective problem as a health promotion problem, potential problem, or actual problem.

Problems defined by the system for clinical practice and documentation may have predefined associations with assessment question response options stored in the memory 122. In this regard, assessment question response options selected during a patient assessment may define a set of identified signs and symptoms (e.g., the signs and symptoms 302) for the patient, for which predefined associations between the selected assessment question response options and problems (e.g., the problems 308 and/or problem descriptions 306) may be determined. Accordingly, the clinical care unit 128 may be configured to process patient assessment data (e.g., the signs and symptoms 302) to determine one or more selected assessment question response options. The clinical care unit 128 may be configured to determine one or more problems facing the patient by determining one or more problems (e.g., the problems 308) defined by the system for clinical practice and documentation having a predefined association with the selected assessment question response option(s). The determined problems may have a predefined association with problem descriptions (e.g., the problem descriptions 306) and the clinical care unit 128 may accordingly be configured to determine a problem description, which may serve to provide further information about a determined problem to a caregiver. The clinical care unit 128 may also be configured to determine a classification(s) of a problem by determining one or more classifications having a predefined association with the problem as defined by the system for clinical practice and documentation.

The clinical care unit 128 may further be configured to determine a rating of a problem by determining a predefined association between a selected assessment question response option(s) and a problem rating, as stored in the memory 122. This rating of the problem may, for example, comprise a rating with respect to one or more of knowledge, behavior, or status. A knowledge rating may comprise a rating of a patient's knowledge of a problem, treatment thereof, and/or the like. A behavior rating may comprise a rating of a patient's behavior with respect to behavior affecting the patient's problem(s). A status rating may comprise a rating of a patient's problem/condition (e.g., severity of signs/symptoms). Determined knowledge, behavior, and status ratings may be used by the clinical care unit 128 to derive a “KBS Score” (Knowledge, Behavior, Status Score). In the example embodiment illustrated in FIG. 3, the problem rating scale 318 is illustrated to have a predefined association with assessment question response option(s) included in the set of identified signs and symptoms 302. Accordingly, the clinical care unit 128 may determine a problem rating(s) defined by the problem rating scale 318 having a predefined association with one or more determined assessment question response options.

The system for clinical practice and documentation may further comprise an outcomes component defining outcomes (e.g., goals) expected to result from applying respective interventions to respective problems. Accordingly, a problem defined by the system for clinical practice and documentation in accordance with some embodiments of the invention will have an association with a goal defined. This goal may be defined by the system for clinical practice and documentation, one or more attending clinicians, or some combination thereof. In this regard, the example embodiment illustrated in FIG. 3 comprises short term goals 320 and long term goals 322 having predefined associations with the problems 308. It will be appreciated, however, that in other embodiments, the short term goals 320 and long term goals 322 may be combined to more generally define all goals associated with treatment of a determined problem. The outcomes component may define goals in terms of a rating scale (e.g., the problem rating scale 318) with respect to one or more of knowledge, behavior, or status (e.g., a KBS score as previously described). In this regard, a goal may, for example, comprise a goal to improve a patient's KBS score and/or other rating scale score through treatment of the patient, such as by applying a determined intervention to address a patient's problem. The clinical care unit 128 may thus be configured to determine a goal(s) of treatment by determining a goal(s) having a predefined association between determined problem(s) as defined by the system for clinical practice and documentation.

The interventions (e.g., intervention targets 314) defined by the intervention component may include any action or activity that may be implemented to address a problem of a patient, improve health of a patient, maintain health of a patient, restore health of a patient, prevent illness of a patient, and/or the like. The interventions may have a predefined association with respective problems and/or with respective assessment question response options. The clinical care unit 128 may accordingly be configured to determine one or more interventions to treat the determined problem(s) based upon predefined associations between problems and interventions as defined by the system for clinical practice and documentation. In embodiments wherein the Omaha System is used as a basis for the system for clinical practice and documentation, such as, for example, the embodiment illustrated in FIG. 3, the interventions may comprise 76 intervention targets 314.

The interventions component may include predefined associations between interventions (e.g., the intervention targets 314) and respective intervention categories (e.g., the intervention categories 312). The categories of interventions may include, for example, “Teaching, Guidance, and Counseling,” which may include interventions that provide information and materials to a patient, the patient's family, and/or the patient's community to encourage better responsibility and knowledge for care. Another example category of interventions is “Treatments and Procedures,” which may include activities such as wound care, specimen collection, exercises, medications, and/or the like that are designed to prevent, decrease, or alleviate signs and symptoms. A further example category of interventions is “Case Management.” An additional example category of interventions is “Surveillance,” which may include detection, monitoring, measurement, and/or other forms of surveillance used to identify a status. The clinical care unit 128 may also be configured to determine a category of intervention based at least in part upon a predefined association between a determined intervention and a category of that intervention, such as may be specified by the system for clinical practice and documentation.

Interventions may further have a predefined association with respective intervention descriptions. In this regard, an intervention description may include a more detailed description of an intervention that would be appropriate based on the assessment findings and best/evidence-based practice guidance and provide instruction to a caregiver on how to perform the invention. In some embodiments, interventions are associated with the discipline(s) qualified to perform the intervention. Accordingly, assessment question response options indicative of the need for another discipline may be associated with an intervention describing a referral to that discipline. If use of a discipline associated with an intervention requires a physician order, the assessment question response option and/or intervention may be further associated with an indication to acquire a physician order for the intervention. In the embodiment illustrated in FIG. 3, the intervention descriptions 316 are illustrated to have a predefined relationship with the intervention targets 314. Accordingly, the clinical care unit 128 may be configured to determine a description for an intervention based on a predefined association between the intervention and an intervention description.

In some embodiments, the clinical care unit 128 is configured to align a determined intervention to an appropriate target, for example the patient or caregiver or both based at least in part on a discipline appropriate to perform the intervention for addressing the determined problem, a classification of the problem which the intervention is to address, and/or a category of intervention having a predefined association with the intervention. For example, an intervention related to improving the environment of a patient, such as by reducing the patient's exposure to second hand smoke, may be assigned to one or more family members living with the patient. In another example, an intervention for applying treatment to a wound may be assigned to a nurse, physician, spiritual adviser, and/or other caregiver.

The clinical data content may further comprise one or more standardized terminology sets used for specification of diseases, medical problems, interventions and/or the like by physicians and/or other medical workers for documentation purposes. These standardized terminology sets may specify a set of codes, terms, clinical terminology identifiers, and/or the like for documenting patient conditions and/or treatments. For purposes of this description, codes, terms, and clinical terminology identifiers may be used interchangeably when referring to standardized terminology sets for documenting patient conditions and/or treatments. For example, one such standardized terminology set may include one or more versions of International Classification of Diseases (ICD) codes, such as, for example, ICD-9, ICD-10, and/or any previous or subsequent versions of ICD codes. Other examples of standardized terminology sets include various versions of Logical Observation Identifiers Names and Codes (LOINC), Systemized Nomenclature of Medicine—Clinical Terms (SNOMED-CT), International Classification for Nursing Practice (ICNP), International Code for Functioning, Disability, and Health (ICF), and/or the like. The standardized classification codes may have predefined associations with assessment question response options and/or with problems, interventions, and/or the like defined by the system for clinical practice and documentation. Accordingly, the clinical care unit 128 may be configured to determine one or more codes in accordance with a standardized terminology set based at least in part on a determined assessment question response option(s). In this regard, the clinical care unit 128 may be configured to determine one or more codes using predefined associations with assessment question response options and/or using predefined associations with problem(s), intervention(s), and/or the like determined based on one or more determined assessment question response options . Such determined codes may be utilized by the clinical care unit 128 to document patient condition, treatment, progress, and/or the like. As another example, the clinical care unit 128 may use determined codes to facilitate population and/or update of an electronic health record for a patient. The electronic health record may be provided to and/or stored on a third party network node 210. Accordingly, the clinical care unit 128 may be configured to direct access of and exchange of information with a third party network node 210 in order to update a patient's electronic health record.

In some embodiments, the clinical data content comprises one or more terminology sets used for documentation of patient diagnosis and treatment by insurance providers for reporting of claims and the like. Such insurance providers may include, for example, private insurers, government insurance programs (e.g., Medicare), and/or the like. For example, the clinical data content may comprise an Outcome and Assessment Information Set (OASIS, including version OASIS-C as well as previous and subsequent versions). Codes, terms, and/or the like specified by a terminology set used for insurance documentation may have predefined associations with respective assessment question response options, problems, interventions, and/or the like. The clinical care unit 128 may accordingly be configured to determine terminology (e.g., a data set) for documenting a patient's case for an insurance payer based at least in part on one or more of a determined assessment question response option(s), determined problem(s), determined intervention(s), and/or the like. The clinical care unit 128 may be configured to direct submission of the determined data set to an insurance provider, such as by directing transmission of the determined data set to a third party network node 210 maintained or otherwise accessible by such an insurance provider.

The clinical care unit 128 may be configured to provide a user interface for defining associations between clinical data content and assessment question response options. The user interface may comprise a graphical user interface and the clinical care unit 128 may be configured to cause the user interface to be displayed on a display, such as may be in operative communication with the care management apparatus 102 and/or with a user terminal 208. In this regard, FIGS. 4-9 illustrate a series of screen captures according to an example user interface for defining associations between clinical data content and assessment question response options according to an example embodiment of the invention. It will be appreciated that these screen captures are provided by way of example and not by way of limitation. Accordingly, the selection and arrangement of options as well as the process for defining associations illustrated in FIGS. 4-9 may vary from other embodiments of the invention. The user interface illustrated in FIGS. 4-9 may be managed by the clinical care unit 128 such that the clinical care unit 128 may determine user input to the user interface and use that input to define assessment questions, define associations between assessment question response options and clinical data content, and/or the like.

Referring now to FIG. 4, FIG. 4 illustrates a screen capture of an example interface allowing for the development of assessment questions and for defining associations between the developed assessment questions and clinical data content. An entry form 402 may allow for a user to define assessment question text. The form 404 may allow a user to define a type of the assessment question (e.g., yes/no, multiple choice, true/false, and/or the like). The form 406 may allow a user to define a gender rule for an assessment question. For example, an assessment question may be applicable to a male patient, but not to a female patient. The form 408 may allow a user to define an age rule for an assessment question. In this regard, an assessment question may be applicable to an individual over a predefined age, but not to an individual under a predefined age. In another example, an assessment question may be applicable to an individual that is at least a first predefined age, but not older than a second predefined age. Accordingly, age and gender rules may be used to specify question applicability such that the clinical care unit 128 may use a patient's sex and/or age to filter an assessment question set when providing assessment questions for a clinician to assess a patient.

A user may further associate a scale (e.g., a problem rating scale) with an assessment question using the form 410. Tip text, such as advice to a clinician administering an assessment on how to assess the question may be entered and associated with the question using the form 412. The user defining an assessment question may additionally associate one or more disciplines with the question, such as, for example, by selecting one or more disciplines from the list of disciplines 414. After defining an assessment question, the user may link/unlink an assessment question response option (e.g., an answer) to the assessment question by selecting the option 416 to link/unlink an answer to the assessment question. A user may further link/unlink an assessment question response option to a problem (e.g., a problem defined by a system for clinical practice and documentation) by selecting the option 418 to link/unlink an assessment question response option to the problem.

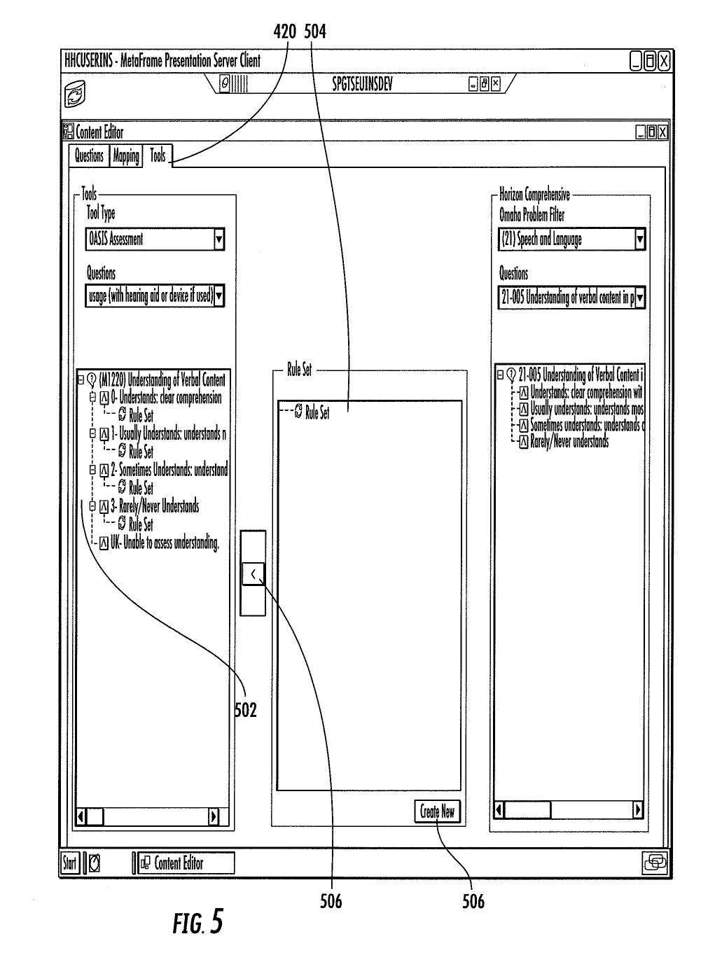

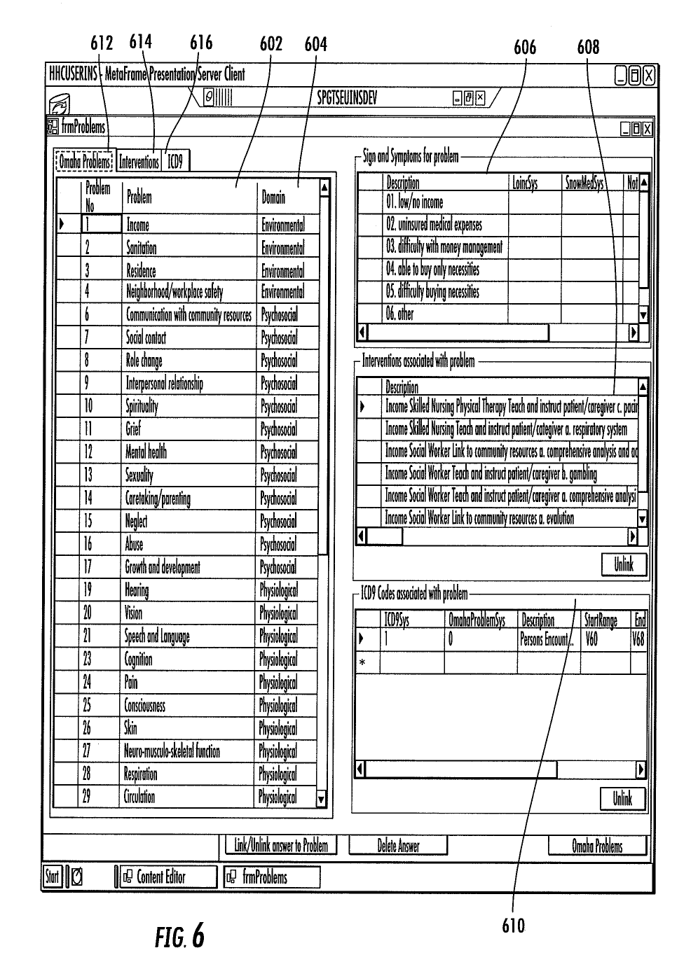

FIG. 5 illustrates a screen capture of an example interface allowing a user to define associations and mappings between assessment question response options and terms of standardized terminology sets, responses to standardized assessment risk measurement tools (e.g., falls risk, Braden Scale, and/or the like), and/or the like. In this regard, for example, one or more assessment question response options may be displayed in a form 502. The form 504 may display one or more rules or terms of a standardized terminology set and/or one or more responses to a standardized assessment risk measurement tool. A user may then use association definition controls 506 to define an association between an assessment question response option and a term of a standardized terminology set and/or a response to a standardized assessment risk measurement tool. The interface of FIG. 5 may, for example, be accessed by selecting a tab, such as tools tab 420, when viewing another portion of the interface illustrated in FIGS. 4-9.

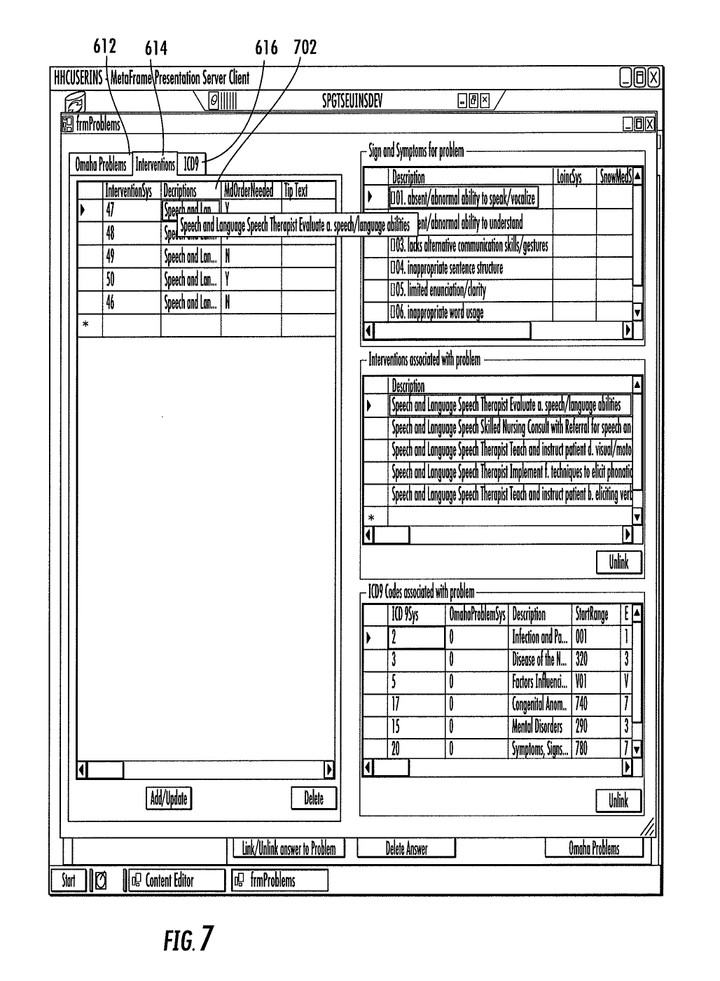

FIG. 6 illustrates a screen capture of an example interface for accessing and defining associations between problems defined by a system for clinical practice and documentation (e.g., the Omaha System) and other clinical data content. In this regard, a column 602 may list a plurality of problems. A problem may be associated with a respective domain or category of the problem (e.g., environmental, psychosocial, physiological, etc) as defined in the domain column 604. The signs and symptoms form 606 may display signs and symptoms of a selected problem. In FIG. 6, the problem “income” has been selected and signs and symptoms for an income problem are displayed in the signs and symptoms form 606. The form 608 may display interventions associated with a selected problem. The form 610 may display one or more standardized terminology set terms associated with a selected problem. In the example of FIG. 6, an ICD9 code associated with a selected problem is displayed.

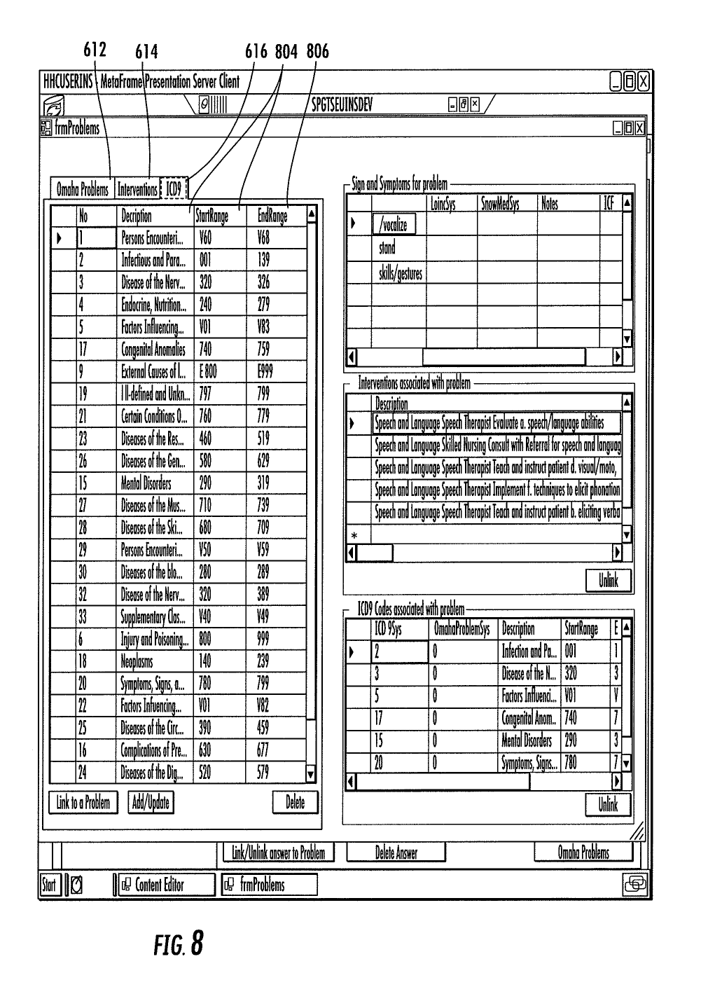

When a user selects the interventions tab 614, the interface illustrated in the screen capture of FIG. 7 may be displayed. In this regard, FIG. 7 illustrates an example interface for creating interventions appropriate to applicable signs and symptoms identified by assessment question response options and for associating interventions with respective assessment question response options. The column 702 may, for example illustrate defined interventions.

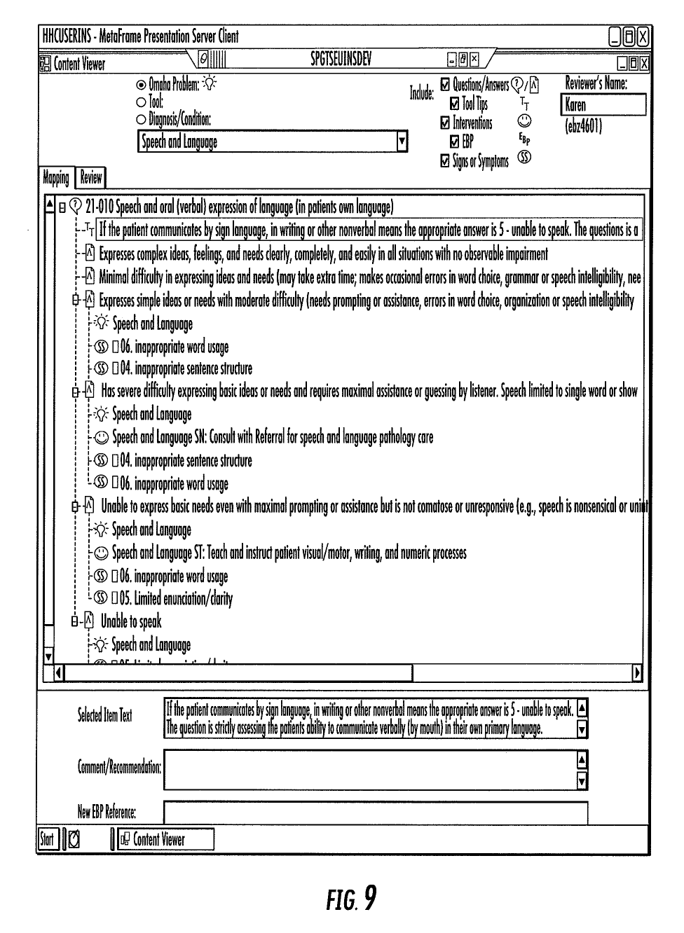

When a user selects the ICD9 tab 616, the interface illustrated in the screen capture of FIG. 8 will be displayed. In this regard, FIG. 8 illustrates an example interface for defining an association between a problem and one or more ICD9 codes. It will be appreciated, however, that ICD9 is used for purposes of example and the interface illustrated may be adapted for use with one or more other standardized terminology sets in addition to or in lieu of ICD9. In one example, a problem listed in the column 802 may be associated with one or more ICD9 codes by specifying an ICD9 code start range for a problem in the column 804 and an ICD9 code end of code range for the problem in the column 806. In this regard, a problem may be associated with a range of ICD9 codes having a starting value specified in the column 804 and an ending value specified in the column 806 (e.g., ICD9 codes 60-68). It will be appreciated, however, that embodiments of the invention also provide for association of a problem with a plurality of ICD9 codes that do fall in a continuous range (e.g., ICD9 codes 30, 31-33, and 54). A user may return to the interface illustrated in FIG. 6 by selecting the problems tab 612 when viewing the interface of FIG. 7 or 8.

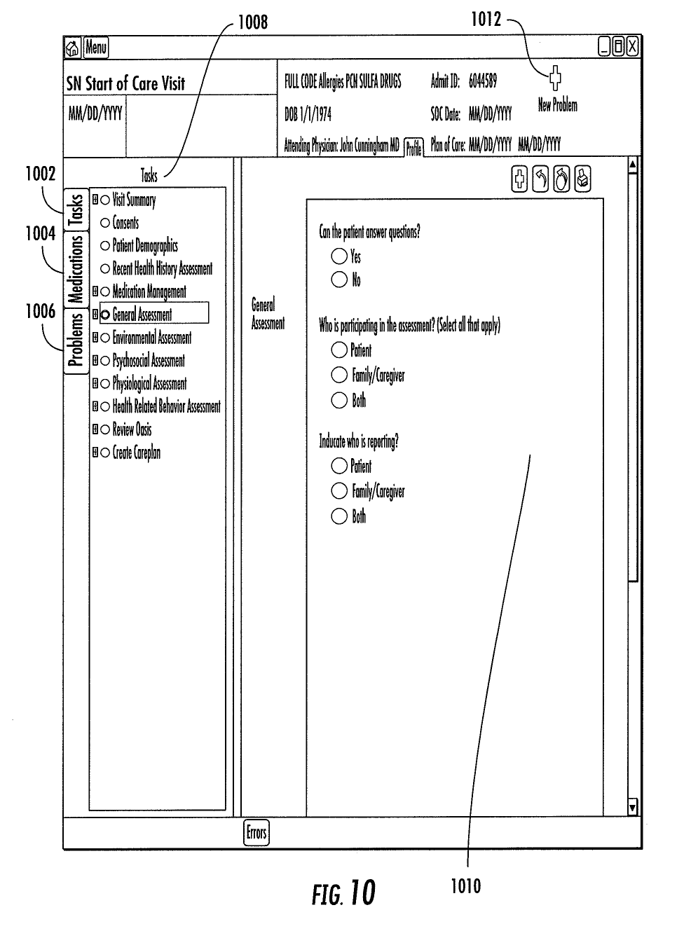

FIG. 9 illustrates an example interface for reviewing associations that may have been created using the interfaces of FIGS. 4-7. In this regard, FIG. 8 may illustrate a hierarchy having an assessment question, associated assessment question response options, associated problem(s), associated intervention(s), associated tip text(s), associated standardized terminology set term(s), associated response(s) to a standardized assessment risk measurement tool, and/or the like.

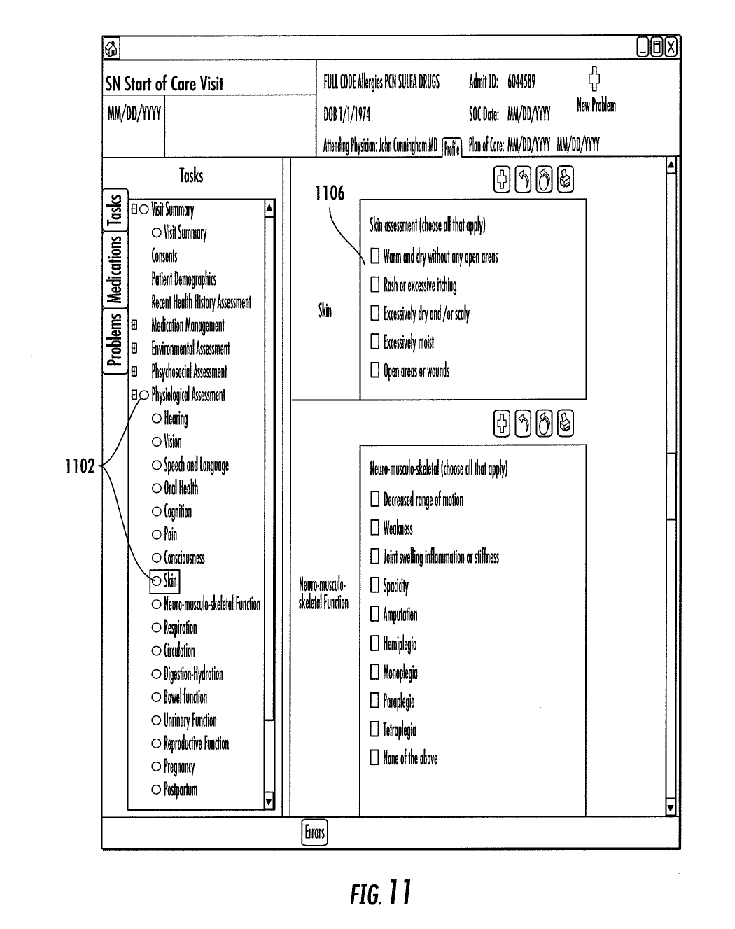

Further aspects of embodiments of the invention will now be described with respect to FIGS. 10-20. In this regard, FIGS. 10-20 illustrate an interface and method for assessing a patient, generating a care plan, and documenting progress on the care plan according to an example embodiment of the invention. Display and control of the interface illustrated in FIGS. 10-20 may be directed by the clinical care unit 128. In describing FIGS. 10-20, references to a user and clinician may be used interchangeably.

Referring now to FIG. 10, an initial patient assessment screen is displayed. On the left side of the screen, an assessment navigational menu may be displayed. The navigational menu may comprise tabs for assessment tasks 1002, a tab 1004 for documentation/verification of medications taken by a patient, and a tab 1006 for accessing any problems determined to be facing the patient by the clinical care unit 128 based on assessment question response options selected during the assessment.

When the tasks tab 1002 is selected, a tasks list 1008 may be displayed in the navigational menu portion of the screen. This tasks list 1008 may comprise an expandable/collapsible hierarchy of assessment questions grouped by subject matter. For example, the assessment questions may be grouped into groups of visit summary questions, consents questions, patient demographics questions, recent health history assessment questions, medication management questions, general assessment questions, environmental assessment questions, psychosocial assessment questions, physiological assessment questions, health related behavior assessment questions, and/or other groups of questions.

A right hand portion of the screen 1010 may display one or more assessment questions and selectable assessment question response options for a group of assessment questions selected in the tasks list 10008. The interface illustrated in FIGS. 10-20 may provide an option 1012 to allow a clinician to manually add a new problem to a patient's care plan on the fly. In this regard, the clinical care unit 128 may be configured to determine a problem facing a patient based on a user-selected problem in addition based on a predefined association between a problem and a determined assessment question response option.

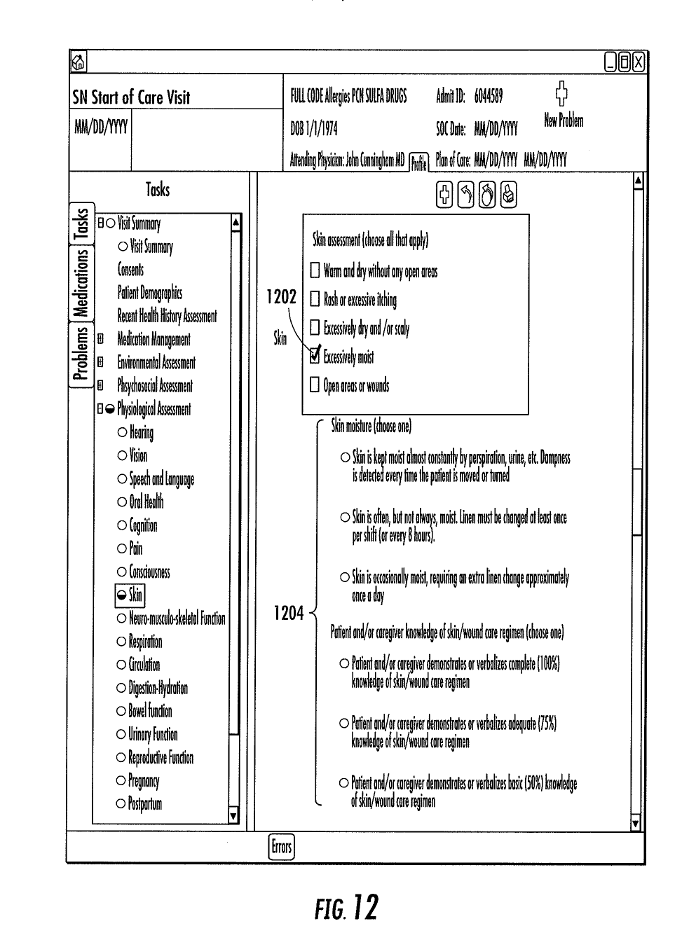

Referring now to FIG. 11, a user has selected the group of physiological assessment questions 1102 from the tasks list. The physiological assessment questions are grouped into a plurality of subgroups, which are displayed as a hierarchy underneath the parent group. The subgroup 1104 for skin assessment questions has been selected and an assessment question 1106 for assessing a patient skin condition is displayed in the right hand portion of the interface. Referring now to FIG. 12, a clinician has selected an assessment question response option 1202 indicating that the patient's skin is excessively moist. The clinical care unit 128 may be configured to determine the selected assessment question response option 1202 and further determine a problem (e.g., a skin problem) associated with the selected assessment question response option 1202.

The clinical care unit 128 may be additionally configured to determine one or more additional assessment questions 1204 that are associated with the selected assessment question response option 1202 and/or with a problem determined based on the selected assessment question response option 1202. The clinical care unit 128 may be further configured to cause those additional assessment questions 1204 to be displayed to facilitate the clinician's further assessment of the patient. The additional assessment questions may, for example, be directed toward a status or severity of the problem, patient/caregiver knowledge of the problem and associated care regiment, and/or patient/caregiver behavior with respect to compliance with the care regimen for the problem to facilitate the derivation of a KBS score by the clinical care unit 128 for the skin problem based on assessment question response options selected for the additional assessment questions 1204.

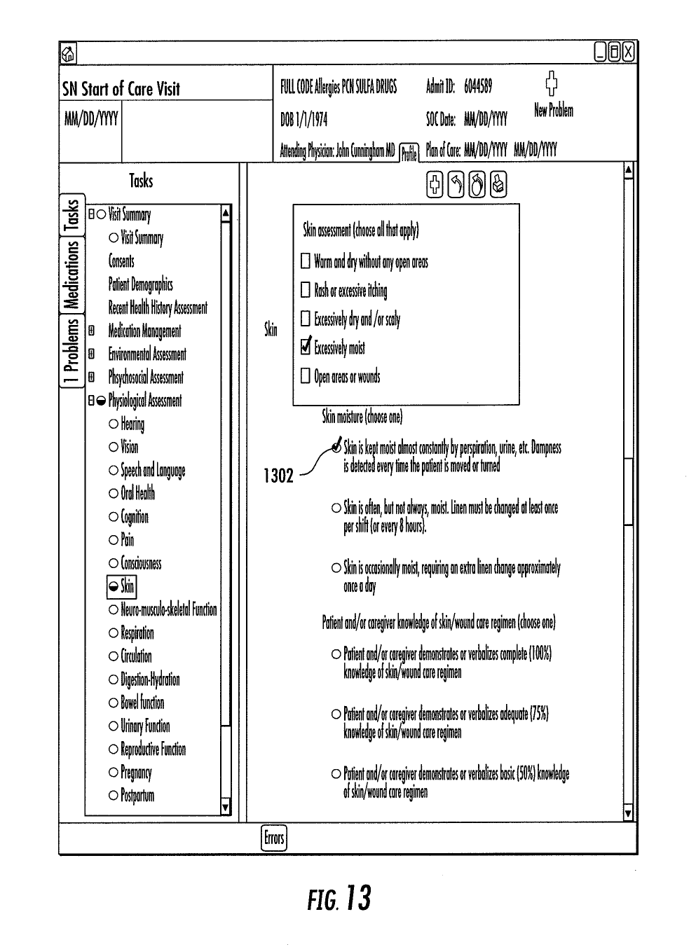

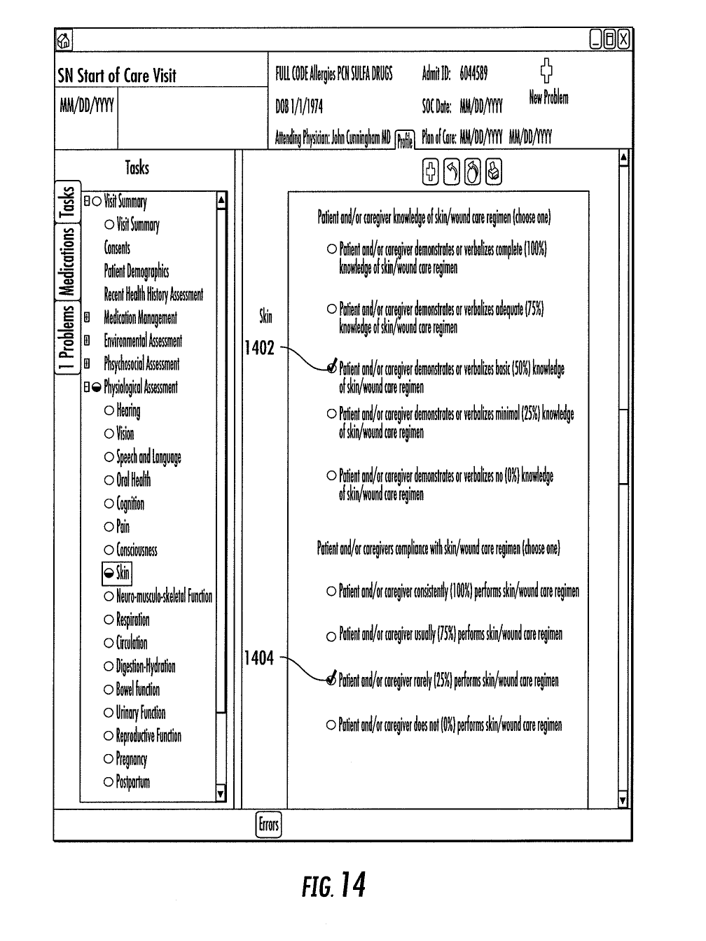

Referring now to FIG. 13, the clinician has selected an assessment question response option 1302 indicating that the status of the skin moisture problem is that the “Skin is kept moist almost constantly by perspiration, urine, etc. Dampness is detected every time the patient is moved or turned. Looking now at FIG. 14, the clinician has selected with respect to patient/caregiver knowledge of the skin care regimen the assessment question response option 1402 indicating that the “Patient and/or caregiver demonstrates or verbalizes basic {50%} knowledge of skin/wound care regimen.” The clinician has additionally selected the assessment question response option 1404 indicating with respect to the patient/caregiver behavior that the “Patient and/or caregiver rarely {25%} performs skin/wound care regimen.”

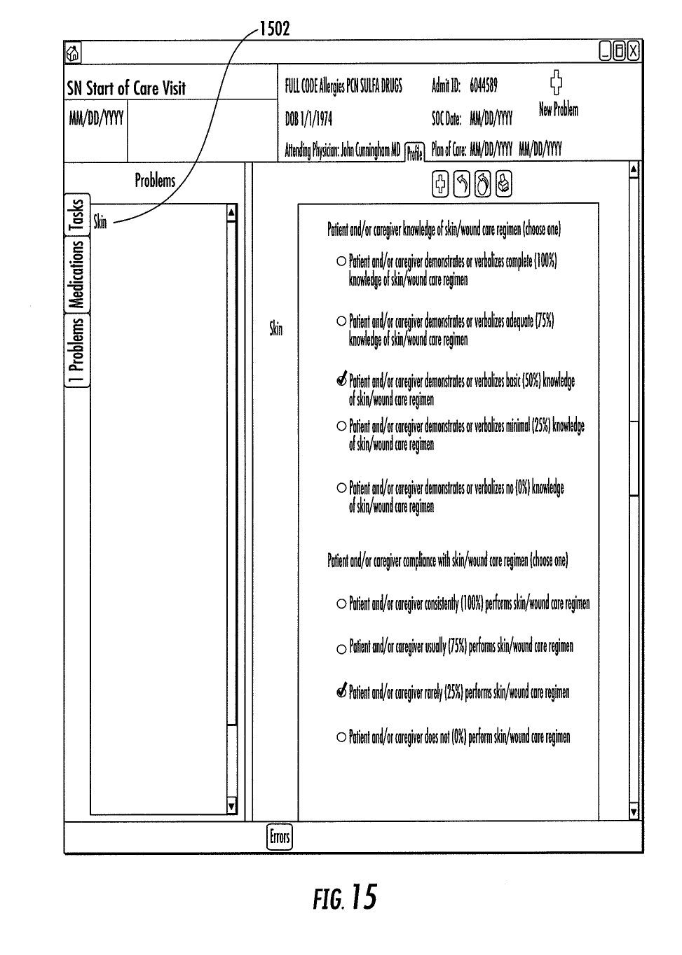

In FIG. 15, the user has selected the problems tab 1006. When the problems tab 1006 is selected, problems determined by the clinical care unit 128 to be facing the patient based on assessment questions answered thus far may be displayed in the navigational menu portion of the screen. In FIG. 15, a skin problem 1502 has been determined based on the assessment question response options selected in FIGS. 12-14 and is displayed. In some embodiments, when multiple problems have been determined to be facing a patient, the clinical care unit 128 may be configured to rank the determined problems by priority of treatment. The ranked problems may be displayed in order of their ranking (e.g., highest priority problem first).

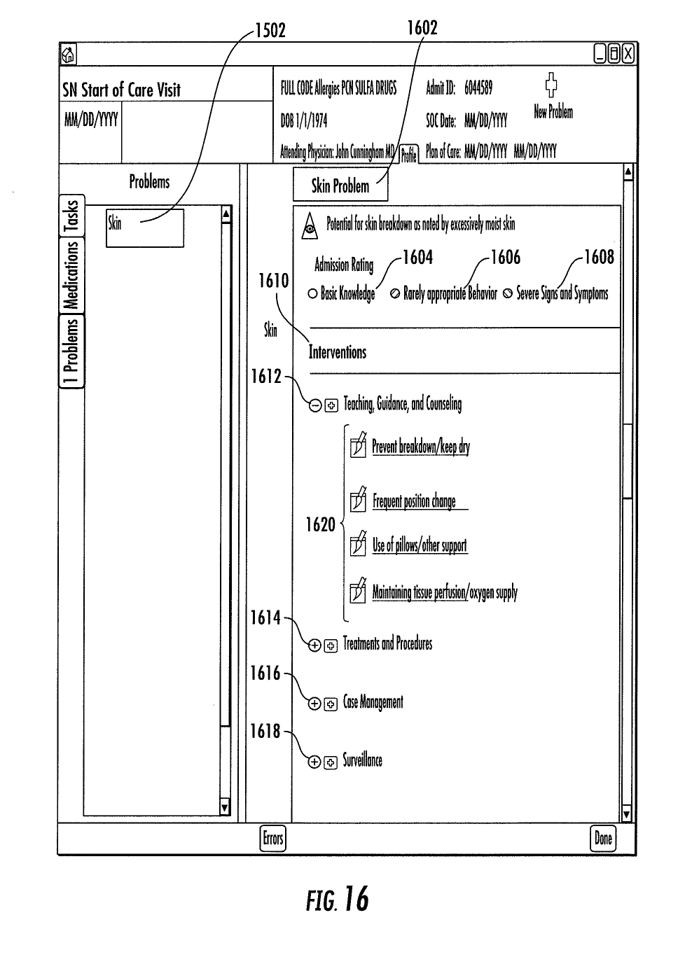

The user may select a displayed problem from the list of determined problems in order to review interventions for the problem, a problem rating score (e.g., KBS score), and/or the like for the problem as determined by the clinical care unit 128. Referring now to FIG. 16, the user has selected the skin problem 1502 from the navigational menu portion of the screen and information for the skin problem is illustrated in the right hand portion of the screen. In this regard, information about the skin problem is displayed under the heading SKIN PROBLEM 1602. A KBS score is displayed indicating that the patient has basic knowledge 1604, rarely appropriate behavior 1606, and severe signs and symptoms 1608. These KBS score indicators 1604-1608 may be derived by the clinical care unit 128 based on determined selected assessment question response options to the additional assessment questions 1204.

The clinical care unit 128 may further determine one or more interventions for treating the skin problem. The clinical care unit 128 may additionally generate a care plan for treating the problem comprising the determined interventions, at least a portion of which may be displayed in the interventions section 1610. The determined interventions may be grouped by type of intervention and displayed in hierarchical groups in the interventions section 1610. For example, the groups of interventions for treating the skin problem may include: teaching, guidance, and counseling interventions 1612; treatments and procedures interventions 1614; case management interventions 1616; and surveillance interventions 1618. The groups of interventions may be displayed in the interventions section 1610 as a collapsible/expandable hierarchy. In FIG. 16, the user has selected to expand the teaching, guidance, and counseling interventions 1612 hierarchy such that the interventions 1620 that are grouped in the teaching, guidance, and counseling interventions group 1612 are displayed.

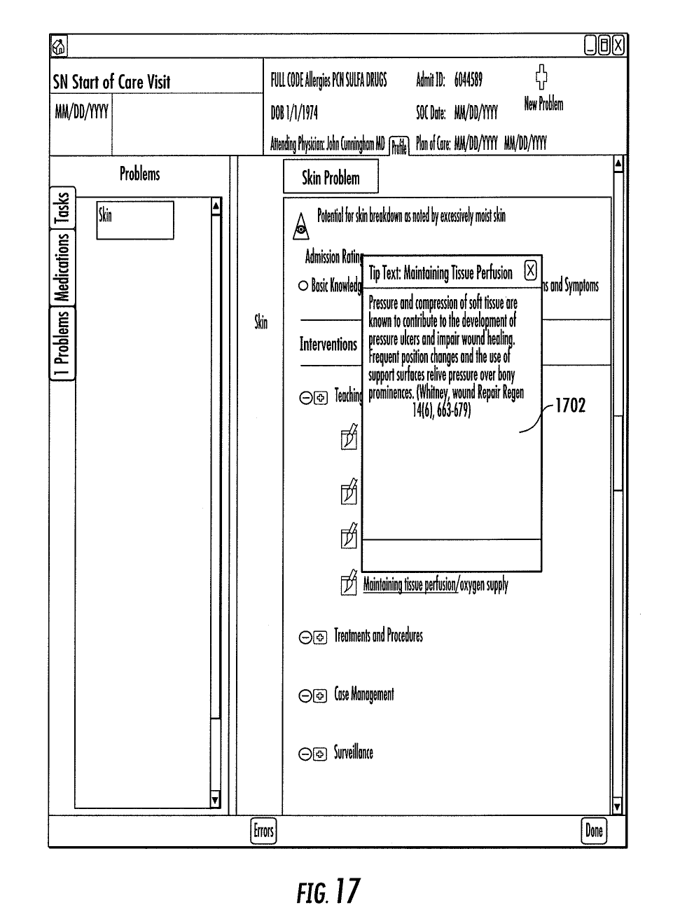

The interventions 1620 may be selectable in order to allow the user to access additional information, tip text, and/or the like for administering the intervention. For example, the user may select the intervention “Maintaining tissue perfusion/oxygen supply.” In response to selection of this intervention, tip text 1702 may be displayed, as illustrated in FIG. 17. The tip text 1702 may be used by the user to facilitate guiding the patient/caregiver on maintaining tissue perfusion/oxygen supply in order to address the patient/caregiver's knowledge of the skin problem and related care regimen.

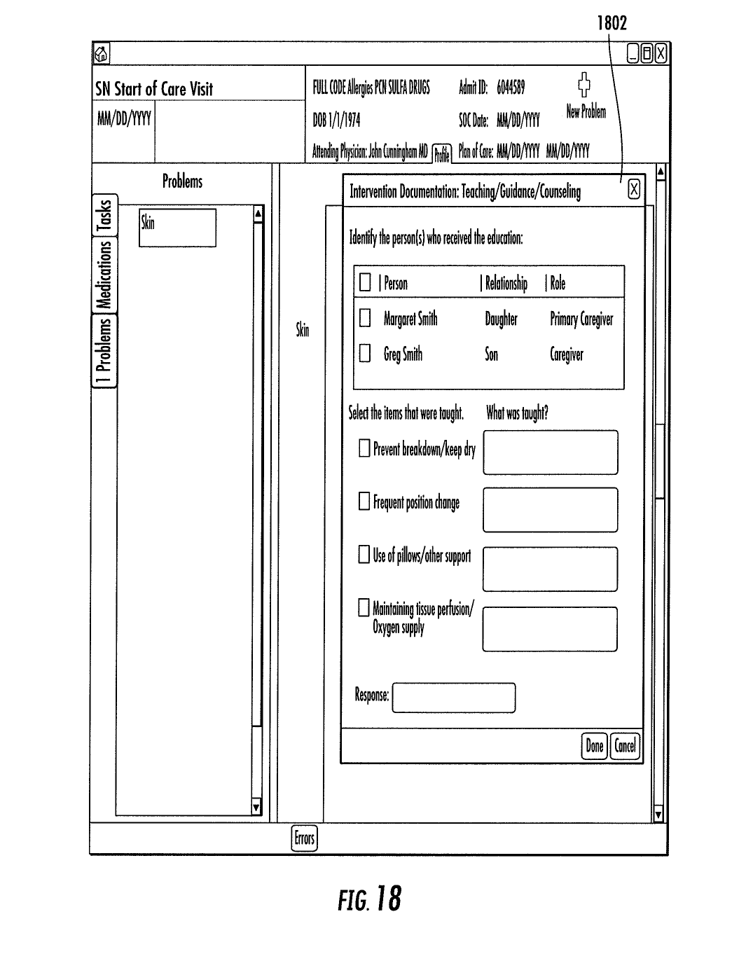

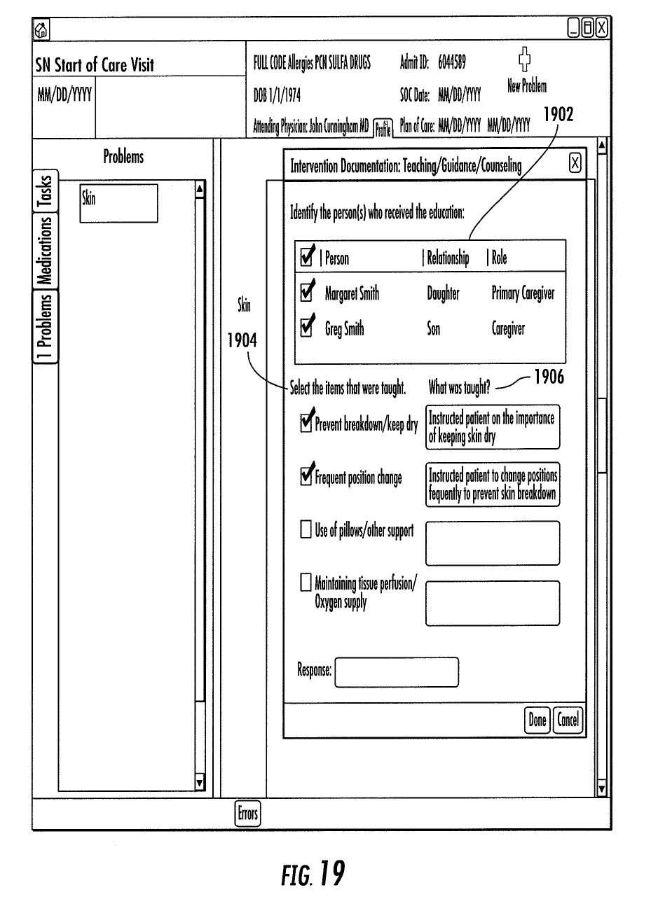

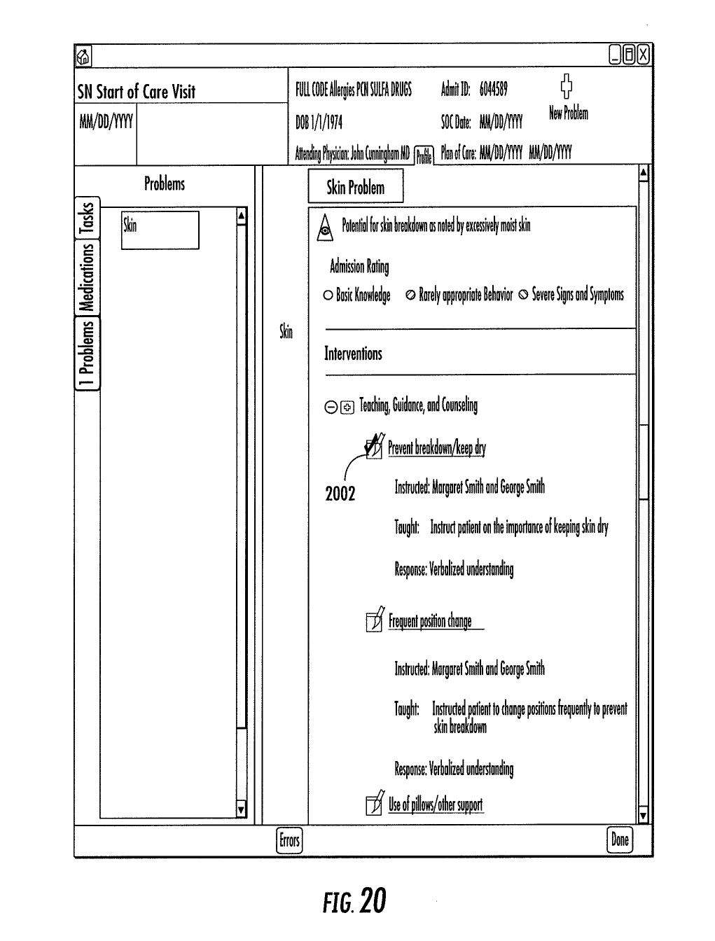

After the clinician has performed one or more of the determined interventions in accordance with the care plan generated by the clinical care unit 128, the clinician may document the intervention(s) performed. In this regard, the clinical care unit 128 may be configured to cause an intervention documentation form 1802 to be displayed, as illustrated in FIG. 18. The intervention documentation form 1802 is for documentation of interventions for teaching/guidance/counseling of the patient and/or caregiver(s), such as, to improve the knowledge score of the patient/caregiver(s). Referring now to FIG. 19, the clinician has identified the persons 1902 which the clinician has provided education with respect to a care regimen. The clinician has further selected the items 1904 which were taught (e.g., the interventions that were performed) and provided further detail 1906 with respect to what was taught. Accordingly, the clinical care unit 128 may determine from the documentation entered by the clinician into the documentation form 1802 what interventions have been performed and update the care plan accordingly. In this regard, referring now to FIG. 20, a check mark 2002 is displayed next to the intervention “Prevent breakdown/keep dry” to indicate that the intervention has been performed.

In addition to those features described with respect to FIGS. 10-20 and/or otherwise previously described, embodiments of the invention may further provide additional features. In some embodiments, the clinical care unit 128 is configured to generate and update a care plan including determined interventions for one or more problems on the fly as problems are determined based on selected assessment question response options. The clinical care unit 128 is configured in some embodiments to generate and/or update a care plan upon completion of a group of assessment questions or upon completion of an entire set of assessment questions. In further embodiments, the clinical care unit 128 is configured to generate and/or update the care plan when requested by the clinician administering an assessment. In addition to determined interventions, the generated care plan may further comprise one or more goals of clinical care. These goals may comprise goals with respect to an expected outcome of applying the determined interventions to treat the determined problems. Such goals may, as previously described, be tied to an improvement of a determined problem rating score (e.g., a KBS score or component thereof).

In some embodiments, the clinical care unit 128 may be configured to determine whether a determined intervention requires a physician order prior to inclusion of the intervention in the care plan and/or prior to performance of the intervention. In such embodiments, the clinical care unit 128 may be configured to prompt the clinician to consult with the appropriate physician prior to inclusion of the intervention in the care plan. Additionally or alternatively, the clinical care unit 128 may be configured to direct an electronic communication to the physician and/or to the physician's office requesting authorization for inclusion of the intervention in the patient's care plan. In another example embodiment, the clinical care unit 128 may be configured to prompt the clinician to obtain a physician order prior to performing an intervention included in a patient's care plan prior to performance of the intervention when a physician order has not been previously obtained and is required prior to performing the intervention.

In some embodiments, the clinical care unit 128 is configured to compare one or more problems determined based on selected assessment question response options to a patient's medical records. In this regard, the clinical care unit 128 may be configured to compare the determined problems to the patient's electronic health record and/or to another available medical record(s) for the patient. In some embodiments, the clinical care unit 128 may be configured to determine standardized terminology set codes, such as, ICD codes, associated with determined problems. The clinical care unit 128 may then search the patient's medical records to determine whether the determined codes have been previously documented in the patient's medical records.

When the clinical care unit 128 determines that a problem determined through the clinician assessment has not been previously documented in a medical record of the patient, the clinical care unit 128 may be configured to prompt the clinician to consider adding the determined problem to the patient's medical record and/or to consult with the patient's physician to determine whether the problem should be added to the patient's medical record. In some embodiments, the clinical care unit 128 may be configured to direct an electronic communication to the patient's physician and/or the physician's office reporting that a problem not previously documented in the patient's medical record has been determined through the course of patient assessment by the clinician.

Additionally or alternatively, the clinical care unit 128 may be configured to prompt the clinician to verify the accuracy of the clinician's findings in case the determined problem that has not been previously documented in the patient's medical records is an error. Further, in some embodiments, the clinical care unit 128 is configured to prompt a clinician to verify the accuracy of the clinician's findings when the clinical care unit 128 fails to determine one or more problems that have been previously documented in the patient's medical records. In this regard, if the clinical care unit 128 does not determine based on selected assessment question response options a problem that has been previously documented in the patient's medical records, one or more of the selected assessment question response options may be inaccurate.

During the course of care for a patient, a clinician may perform follow-up assessments following an initial assessment. Such follow-up assessments may be performed in person, via telephone, via email, via videoconference, and/or the like. Regardless of how a follow-up assessment is performed, a clinician may again select one or more assessment question response options for one or more assessment questions to assess the patient's updated condition. This update condition may comprise a patient's condition following administration of at least one intervention contained in a care plan for the patient generated based on a previous patient assessment. The assessment performed during a follow-up assessment may be more limited in scope than a more general assessment that may have been performed during an initial assessment. In this regard, assessment questions that are assessed during a follow-up assessment may be more narrowly targeted in scope to one or more problems determined to be facing the patient in a previous assessment.

The clinical care unit 128 may be configured to process follow-up patient assessment data comprising one or more assessment question response options selected during the follow-up assessment to determine a current status of one or more problems previously determined to be facing the patient. It will be appreciated that “current” is relative to the status of the patient when the assessment was performed and not necessarily when the status is actually determined by the clinical care unit 128. The clinical care unit 128 may additionally be configured to compare the current status to a goal of clinical care included in the patient's care plan to determine whether the status indicates the goal has been met. In this regard, the clinical care unit 128 may determine an effectiveness of the care plane by determining whether treatment based on determined intervention(s) included in the care plan has met the goal of treatment. The clinical care unit 128 may be further configured to update the generated care plan based on the determined effectiveness. In this regard, for example, if the patient is not responding to treatment, such as indicated by not meeting goals, additional interventions(s) may be added to the care plan and/or previously administered intervention(s) may be designated to be repeated in the care plan.

In some embodiments, the current status determined during the follow-up patient assessment comprises a problem rating score (e.g., a KBS score or component thereof). In such embodiments, the goal of treatment may comprise a target problem rating score. Accordingly, the clinical care unit 128 may be configured to evaluate the effectiveness of the care plan by comparing the problem rating score determined during the follow-up assessment to the target problem rating score.

The clinical care unit 128 is configured in some embodiments to facilitate assessment of a patient's medication regimen. In this regard, the clinical care unit 128 may be configured to provide one or more assessment questions for assessment of the patient to assess the patient's medication regimen. These assessment questions may be targeted based on medications that the clinical care unit 128 has determined to have been prescribed to the patient previously, such as based on patient medical records, patient insurance claims, and/or the like. The clinician may then document whether the patient is taking the prescribed medications. Further, if the clinician documents that the patient is taking a medication that has not been prescribed to the patient, the clinical care unit 128 may be configured to alert the clinician and/or a physician to this fact.

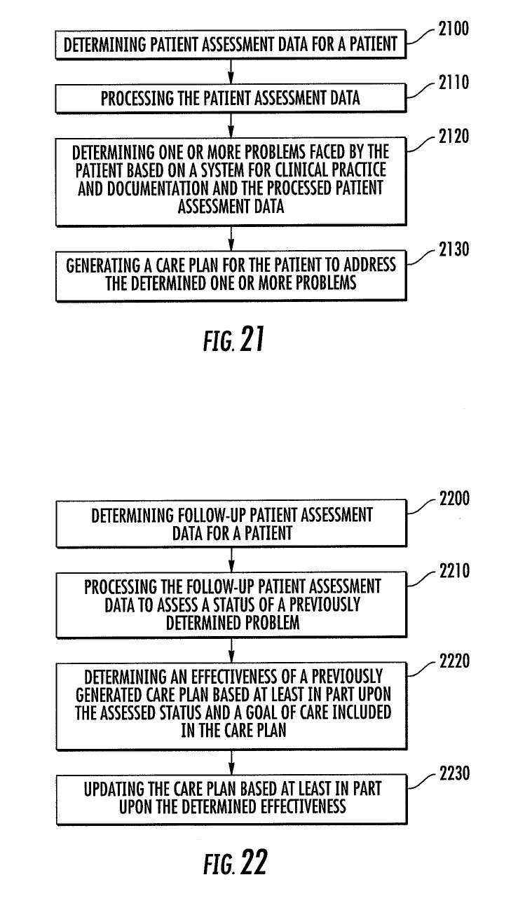

FIG. 21 illustrates a flowchart according to an exemplary method for facilitating development and execution of a clinical care plan according to an exemplary embodiment of the invention. The operations illustrated in FIG. 21 may, for example, be performed and/or under the control of the clinical care unit 128. Operation 2100 comprises determining patient assessment data for a patient. This patient assessment data may, for example, comprise one or more selected assessment question response options. Operation 2110 comprises processing the patient assessment data. In this regard, operation 2110 may comprise determining the selected assessment question response options such that clinical data having a predefined association with the selected assessment question response options may be determined. Operation 2120 comprises determining one or more problems faced by the patient based on a system for clinical practice and documentation and the processed patient assessment data. In this regard, operation 2120 may comprise determining one or more problems defined by the system for clinical practice and documentation that have a predefined association with one or more selected assessment question response options. Operation 2130 comprises generating a care plan for the patient to address the determined one or more problems. In this regard, operation 2130 may comprise determining one or more interventions for treating a determined problem and including the determined interventions in the care plan. Operation 2130 may further comprise determining a goal of care and including the goal in the care plan.

FIG. 22 illustrates a flowchart according to an exemplary method for updating a clinical care plan based on a follow-up assessment according to an exemplary embodiment of the invention. The operations illustrated in FIG. 22 may, for example, be performed and/or under the control of the clinical care unit 128. Operation 2200 comprises determining follow-up patient assessment data for a patient. This follow-up patient assessment data may, for example, comprise one or more selected assessment question response options. Operation 2210 comprises processing the follow-up patient assessment data to assess a status of a problem previously determined to be facing a patient. The status may comprise a problem rating score, such as, for example, a KBS score or component thereof. In this regard, operation 2210 may comprise, for example, determining a problem rating score based at least in part on a predefined association between a score and a selected assessment question response option. Operation 2220 comprises determining an effectiveness of a previously generated care plan based at least in part upon the assessed status and a goal of care included in the care plan. The goal may comprise a target problem rating score targeted for achievement following implementation of one or more interventions included in the care plan. In this regard, operation 2220 may comprise comparing the determined problem rating score to the target problem rating score to evaluate whether the target problem rating score has been achieved. Operation 2230 comprises updating the care plan based at least in part upon the determined effectiveness.

FIGS. 21-22 comprise flowcharts of a system, method, and computer program product according to exemplary embodiments of the invention. It will be understood that each block or step of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., the care management apparatus 102) and executed by a processor (e.g., the processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to clinicians, healthcare settings, payers (e.g. government and private insurers), and patients. Embodiments of the invention provide for automatic determination of one or more problems facing a patient and generation of a care plan to address the determined care problems based on patient assessment data. The problems may be determined and the care plan may be generated by embodiments of the invention in accordance with best and evidence based practice. In this regard, embodiments of the invention may reduce the burden imposed on clinicians to develop a care plan while also ensuring consistency with best and evidence based practice, thus reducing clinician burden and improving the consistency in the care provided. Some embodiments of the invention further facilitate generation of documentation in accordance with various standardized terminology sets to simplify the provision of documentation to insurers, electronic health records, and/or the like. Accordingly, embodiments of the invention provide for a standardized approach to assessing the patient that is used to generate assessment data used for a wide range of clinical documentation.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for facilitating development and execution of a clinical care plan, the method comprising:
determining patient assessment data for a patient;
processing the patient assessment data, by a clinical care unit, to determine based at least in part upon a system for clinical practice and documentation a problem faced by the patient; and
generating a care plan for the patient to address the determined problem, wherein generating the care plan comprises:
determining based at least in part upon the determined problem and the system for clinical practice and documentation at least one intervention to treat the problem; and
determining based at least in part upon the determined problem a goal of clinical care.

2. The method of claim 1, wherein the patient assessment data comprises a plurality of responses to patient assessment questions, and wherein processing the patient assessment data comprises processing the plurality of responses to determine the problem by determining a problem having a predefined association with at least one of the responses, wherein the problem is defined by the system for clinical practice and documentation.

3. The method of claim 1, wherein the system for clinical practice and documentation comprises the Omaha system.

4. The method of claim 1, wherein processing the patient assessment data further comprises processing the patient assessment data to determine based at least in part upon the system for clinical practice and documentation:
a classification of the problem as an individual, family, or community problem;
a classification of the problem as a health promotion, potential, or actual problem; and
a rating of the problem with respect to one or more of knowledge, behavior, or status of the problem.

5. The method of claim 1, wherein generating the care plan further comprises assigning a determined intervention to a responsible caretaker based at least in part on a discipline of the problem.

6. The method of claim 1, further comprising:
prompting a clinician to verify the determined problem prior to generating the care plan; and
determining a clinician verification of accuracy of the determined problem; and
wherein generating the care plan comprises generating the care plan in response to determining the clinician verification.

7. The method of claim 1, further comprising determining one or more International Classification of Diseases codes corresponding to the determined problem.

8. The method of claim 7, further comprising:
comparing the determined one or more International Classification of Diseases codes to one or more International Classification of Diseases codes documented in a medical record for the patient to determine whether the determined one or more International Classification of Diseases codes are documented in the medical record; and
prompting a clinician to consider adding an International Classification of Diseases code not documented in the medical record to the medical record when one of the determined one or more International Classification of Diseases codes is not documented in the medical record.

9. The method of claim 1, further comprising determining based at least in part on the patient assessment data a data set required for submission to an insurance provider.

10. The method of claim 1, further comprising:
determining based at least in part on one or more of the determined problem or the patient assessment data one or more standardized clinical terminology identifiers specified by a standardized terminology enabling sharing patient medical data with an electronic health record; and
providing the determined one or more standardized clinical terminology identifiers for inclusion in an electronic health record for the patient.

11. The method of claim 1, further comprising:
determining follow-up patient assessment data for the patient;
processing the follow-up patient assessment data to assess a status of the determined problem;
determining an effectiveness of the care plan based at least in part upon the assessed status of the determined problem and the goal of clinical care; and
updating the generated care plan based at least in part upon the determined effectiveness of the care plan.

12. An apparatus for facilitating development and execution of a clinical care plan, the apparatus comprising a processor configured to cause the apparatus to:
determine patient assessment data for a patient;
process the patient assessment data to determine based at least in part upon a system for clinical practice and documentation a problem faced by the patient; and
generate a care plan for the patient to address the determined problem, wherein the processor is configured to cause the apparatus to generate the care plan by causing the apparatus to:
determine based at least in part upon the determined problem and the system for clinical practice and documentation at least one intervention to treat the problem; and
determine based at least in part upon the determined problem a goal of clinical care.

13. The apparatus of claim 12, wherein the patient assessment data comprises a plurality of responses to patient assessment questions, and wherein the processor is configured to cause the apparatus to process the patient assessment data by processing the plurality of responses to determine a problem having a predefined association with at least one of the responses, wherein the problem is defined by the system for clinical practice and documentation.

14. The apparatus of claim 12, wherein the processor is further configured to cause the apparatus to process the patient assessment data to determine based at least in part upon the system for clinical practice and documentation:
a classification of the problem as an individual, family, or community problem;
a classification of the problem as a health promotion, potential, or actual problem; and
a rating of the problem with respect to one or more of knowledge, behavior, or status of the problem.

15. The apparatus of claim 12, wherein the processor is further configured to cause the apparatus to determine one or more International Classification of Diseases codes corresponding to the determined problem.

16. The apparatus of claim 15, wherein the processor is further configured to cause the apparatus to:
compare the determined one or more International Classification of Diseases codes to one or more International Classification of Diseases codes documented in a medical record for the patient to determine whether the determined one or more International Classification of Diseases codes are documented in the medical record; and
prompt a clinician to consider adding an International Classification of Diseases code not documented in the medical record to the medical record when one of the determined one or more International Classification of Diseases codes is not documented in the medical record.

17. The apparatus of claim 12, wherein the processor is further configured to cause the apparatus to determine based at least in part on the patient assessment data a data set required for submission to an insurance provider.

18. The apparatus of claim 12, wherein the processor is further configured to cause the apparatus to:
determine based at least in part on one or more of the determined problem or the patient assessment data one or more standardized clinical terminology identifiers specified by a standardized terminology enabling sharing patient medical data with an electronic health record; and
provide the determined one or more standardized clinical terminology identifiers for inclusion in an electronic health record for the patient.

19. The apparatus of claim 12, further comprising at least one memory storing instructions that when executed by the processor cause the apparatus to at least:
determine patient assessment data for a patient;
process the patient assessment data to determine based at least in part upon a system for clinical practice and documentation a problem faced by the patient; and
generate a care plan for the patient to address the determined problem, wherein the processor is configured to cause the apparatus to generate the care plan by causing the apparatus to:
determine based at least in part upon the determined problem and the system for clinical practice and documentation at least one intervention to treat the problem; and
determine based at least in part upon the determined problem a goal of clinical care.

20. A computer program product for facilitating development and execution of a clinical care plan, the computer program product comprising at least one computer-readable storage medium having computer-readable program instructions stored therein, the computer-readable program instructions comprising:
program instructions configured for determining patient assessment data for a patient;
program instructions configured for processing the patient assessment data to determine based at least in part upon a system for clinical practice and documentation a problem faced by the patient; and
program instructions configured for generating a care plan for the patient to address the determined problem, wherein the program instructions configured for generating the care plan comprise:
program instructions configured for determining based at least in part upon the determined problem and the system for clinical practice and documentation at least one intervention to treat the problem; and
program instructions configured for determining based at least in part upon the determined problem a goal of clinical care.

21. The computer program product of claim 20, further comprising program instructions configured for determining one or more International Classification of Diseases codes corresponding to the determined problem.

22. The computer program product of claim 21, further comprising:
program instructions configured for comparing the determined one or more International Classification of Diseases codes to one or more International Classification of Diseases codes documented in a medical record for the patient to determine whether the determined one or more International Classification of Diseases codes are documented in the medical record; and
program instructions configured for prompting a clinician to consider adding an International Classification of Diseases code not documented in the medical record to the medical record when one of the determined one or more International Classification of Diseases codes is not documented in the medical record.

23. The computer program product of claim 20, further comprising program instructions configured for determining based at least in part on the patient assessment data a data set required for submission to an insurance provider.

24. The computer program product of claim 20, further comprising:
program instructions configured for determining based at least in part on one or more of the determined problem or the patient assessment data one or more standardized clinical terminology identifiers specified by a standardized terminology enabling sharing patient medical data with an electronic health record; and
program instructions configured for providing the determined one or more standardized clinical terminology identifiers for inclusion in an electronic health record for the patient.

25. The computer program product of claim 20, further comprising:
program instructions configured for determining follow-up patient assessment data for the patient;
program instructions configured for processing the follow-up patient assessment data to assess a status of the determined problem;
program instructions configured for determining an effectiveness of the care plan based at least in part upon the assessed status of the determined problem and the goal of clinical care; and
program instructions configured for updating the generated care plan based at least in part upon the determined effectiveness of the care plan.
